(19) United States
(12) Patent Application Publication
(10) Pub. No.: US 2026/0167192 A1
(43) Pub. Date: Jun. 18, 2026

(54) Steering Control Apparatus for a Vehicle Air Brake System and Methods Therefor

(71) Applicant: R. H. Sheppard Co., Inc, Hanover, PA (US)

(72) Inventor: Linhang Li, Sterling Heights, MI (US)

(21) Appl. No.: 18/978,597

(22) Filed: Dec. 12, 2024

(51) Int. Cl. B60W 30/18; B60W 10/184; B60W 10/20

(52) U.S. Cl. CPC B60W 30/18036; B60W 10/184; B60W 10/20; B60W 2510/20; B60W 2710/182

(57) ABSTRACT

A steering control apparatus is provided for a vehicle train having a tractor towing a trailer. The steering control apparatus comprises a steering-angle position sensor arranged to provide a sensor output signal indicative of steering angle of steering wheels of the tractor. The steering control apparatus also comprises a controller arranged to (i) monitor the sensor output signal of the steering-angle position sensor, and (ii) transmit a signal to apply a differential in brake pressure on one side of opposite wheel ends of the trailer. The applied differential in brake pressure on the one side of the wheel ends of the trailer varies as a non-linear function of the sensor output signal indicative of steering angle of steering wheels of the tractor.

### BACKGROUND

The present application relates to vehicle air braking systems, and is particularly directed to a steering control apparatus for a vehicle air brake system and methods therefor, such as for a vehicle air brake system of a vehicle train having a tractor that is towing a trailer.

In some known vehicle trains having a tractor that is towing a trailer, the vehicle air brake system has a capability to apply a differential in brake pressure on one side of opposite wheel ends of the trailer. The differential in brake pressure applied on the one side of the wheel ends of the trailer provides brake steering of the trailer. Brake steering of the trailer allows direction of the trailer to be controllably steered.

Despite advances already made, those skilled in the art continue with research and development efforts in the field of vehicle air braking systems that can apply a differential in brake pressure on one side of opposite wheel ends of a trailer of a vehicle train.

### SUMMARY

In accordance with one embodiment, a steering control apparatus is provided for a vehicle train having a tractor towing a trailer. The steering control apparatus comprises a steering-angle position sensor arranged to provide a sensor output signal indicative of steering angle of steering wheels of the tractor. The steering control apparatus also comprises a controller arranged to (i) monitor the sensor output signal of the steering-angle position sensor, and (ii) transmit a signal to apply a differential in brake pressure on one side of opposite wheel ends of the trailer. The applied differential in brake pressure on the one side of the wheel ends of the trailer varies as a non-linear function of the sensor output signal indicative of steering angle of steering wheels of the tractor.

In accordance with another embodiment, a steering control apparatus is provided for a vehicle train having a tractor towing a trailer. The steering control apparatus comprises a steering-angle position sensor arranged to provide a sensor output signal indicative of steering angle of steering wheels of the tractor. The steering control apparatus also comprises a controller arranged to (i) monitor the sensor output signal of the steering-angle position sensor, and (ii) transmit a signal to apply a differential in brake pressure on one side of opposite wheel ends of the trailer. The applied differential in brake pressure on the one side of the wheel ends of the trailer varies as a function of the sensor output signal of the steering-angle position sensor modified by a ramp-rate coefficient and an offset coefficient.

In accordance with yet another embodiment, a steering control apparatus is provided for a vehicle train having a tractor towing a trailer. The steering control apparatus comprises a steering-angle position sensor arranged to provide a sensor output signal indicative of steering angle of steering wheels of the tractor. The steering control apparatus also comprises means for transmitting a signal to apply a differential in brake pressure on one side of opposite wheel ends of the trailer such that relationship between the applied differential in brake pressure on the one side of the wheel ends of the trailer and the sensor output signal indicative of steering angle of steering wheels of the tractor is other than a proportional linear relationship.

In accordance with still another embodiment, a method is provided of operating a steering control apparatus of a vehicle train having a tractor towing a trailer. The method comprises monitoring a linear sensor output signal of a steering-angle position sensor of the tractor in a working range of the steering-angle position sensor. The method also comprises transmitting a signal to apply a non-linear differential in brake pressure on one side of opposite wheel ends of the trailer based upon the linear sensor output signal of the steering-angle position sensor of the tractor.

### BRIEF DESCRIPTION OF THE DRAWINGS

FIG. 1 is an overhead pictorial diagram of a tractor of a vehicle train embodying an example steering control apparatus in accordance with the present disclosure.

FIG. 2 is a schematic block diagram of the steering control apparatus of FIG. 1 in accordance with an embodiment.

FIG. 3 is an example equation used in the steering control apparatus of FIG. 2 to calculate a differential in brake pressure that is to be applied to one side of opposite wheel ends of a trailer of the vehicle train as a function of steering angle of a steering-angle position sensor of the tractor.

FIG. 4 shows a number of graphs using various ramp-rate coefficients and offset coefficients in the equation of FIG. 3.

FIG. 5 shows a trailer of the vehicle train of FIG. 1 being brake-steered in a left-reverse direction.

FIG. 6 shows a trailer of the vehicle train of FIG. 1 being brake-steered in a right-reverse direction.

FIG. 7 is a flow diagram depicting a method of operating a steering control apparatus of a vehicle train having a tractor towing a trailer in accordance with an embodiment.

FIG. 8 is a flow diagram depicting a method of operating a steering control apparatus of a vehicle train having a tractor towing a trailer in accordance with another embodiment.

### DETAILED DESCRIPTION

The present application is directed to a steering control apparatus for a vehicle air braking system and methods therefor, such as for a vehicle air braking system of a vehicle train having a tractor towing a trailer. The specific construction of the steering control apparatus may vary. It is to be understood that the disclosure below provides a number of embodiments or examples for implementing different features of various embodiments. Specific examples of components and arrangements are described to simplify the present disclosure. These are merely examples and are not intended to be limiting.

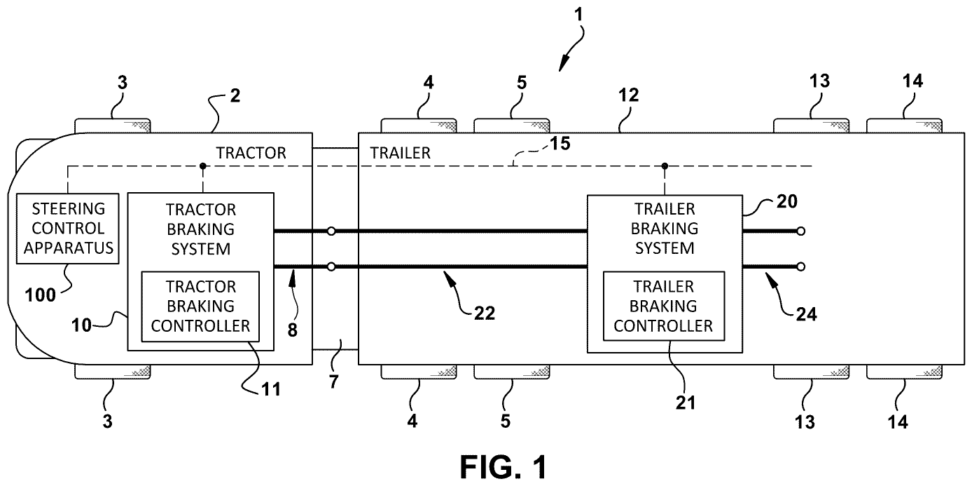

Referring to FIG. 1, an overhead pictorial diagram is illustrated of a tractor 2 of a vehicle train 1 embodying an example steering control apparatus 100 in accordance with the present disclosure. Tractor 2 also comprises tractor braking system 10 having a tractor braking controller 11 that cooperates with the steering control apparatus 100 to provide brake-steering of trailer 12 of the vehicle train 1, as will be described herein. Although the tractor braking controller 11 and the steering control apparatus 100 are shown separate in FIG. 1, it is conceivable that the tractor braking controller 11 and the steering control apparatus 100 be combined and shown together.

Tractor 2 has three wheel axles 3, 4, 5, and a fifth wheel coupling platform 7 that is mechanically coupled to the trailer 12 that has two wheel axles 13, 14. The mechanically coupling of the trailer 12 to the fifth wheel coupling platform 7 is known and conventional and, therefore, will not be described.

Tractor 2 provides electrical power to trailer 12. Tractor braking system 10 is pneumatically connected to a trailer braking system 20 via tractor gladhands 8 that are connected with front gladhands 22 of the trailer 12. Trailer 12 also has rear gladhands 24 that are connectable to a braking system (not shown) of another towable vehicle (e.g., a dolly converter or another trailer). For simplicity and purpose of explanation, only one towable vehicle (i.e., the trailer 12) and, therefore, only one trailer braking system (i.e., the trailer braking system 20) is shown in FIG. 1. Structure and operation of gladhands of vehicle train 1 are known and conventional and, therefore, will not be described. A communication line 15 interconnects the steering control apparatus 100, the tractor braking controller 11 of the tractor braking system 10, and a trailer braking controller 21 of the trailer braking system 20.

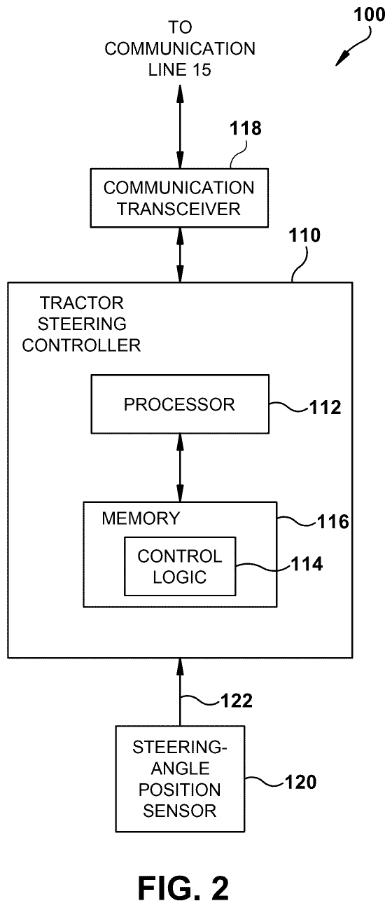

Referring to FIG. 2, a schematic block diagram is illustrated of the steering control apparatus 100 of FIG. 1 in accordance with an embodiment. The steering control apparatus 100 comprises a tractor steering controller 110 having a processor 112 that executes instructions of control logic 114 stored in an internal memory 116, external memory (not shown), or a combination thereof. The processor 112 may comprise any type of technology. For example, the processor 112 may comprise a general-purpose electronic processor. Other types of processors and technologies are possible. The internal memory 116 may comprise any type of technology. For example, the internal memory 116 may comprise random access memory (RAM), read only memory (ROM), solid state memory, or any combination thereof. Other types of memories and data storage technologies are possible.

A communication transceiver 118 enables the tractor steering controller 110 to send/receive signals to/from the communication line 15 that interconnects the steering control apparatus 100 (i.e., the tractor steering controller 110), the tractor braking controller 11 of the tractor braking system 10, and the trailer braking controller 21 of the trailer braking system 20. Structure and operation of transceiver circuits are known and, therefore, will not be described. The transceiver circuits may send/receive signals based upon any type of network communication of the communication line 15.

The communication line 15 may comprise a controller area network (CAN) bus to which a number of vehicle devices are connected to communicate with each other. The CAN bus may be in a standardized serial communication format, such as ISO11992, SAE J1939, or in a proprietary format. The communication line 15 creates a communication path through tractor and trailers that may or may not be shown or described herein via wired (e.g., controller area network (CAN), ethernet, automotive ethernet, etc.) or wireless (e.g., WiFi, Bluetooth, cellular, etc.) connections. In the example of FIG. 1, the components are directly or indirectly connected via the communication line 15, which can take the form of a controller area network (e.g., ISO 11992, SAE J1939, or proprietary format). Other types of network communication are possible.

A steering-angle position sensor 120 provides a steering-angle sensor output signal on line 122, which in turn is a steering-angle input signal to the tractor steering controller 110. The steering-angle position sensor 120 has a target range which is indicative of steering angle of steering wheels of the tractor 10. Structure and operation of steering-angle position sensors for vehicles are known and conventional and, therefore, will not be described.

In accordance with an aspect of the present disclosure, the tractor steering controller 110 monitors the sensor output signal on line 122 from the steering-angle position sensor 120, and applies a differential in brake pressure on one side of opposite wheel ends of the trailer 12 such that the applied differential in brake pressure on the one side of the wheel ends of the trailer 12 varies as a non-linear function of the sensor output signal on line 122. Notably, the applied differential in brake pressure on the one side of the wheel ends of the trailer 12 varies non-linearly in a brake-pressure range between about zero pounds-per-square-inch (psi) and about 120 psi as a function of the sensor output signal on line 122 when the steering-angle position sensor 120 is operating in a target range between about −45 degrees and about 45 degrees as the tractor 2 is engaged in reverse gear and moving the trailer 12 in reverse direction of the vehicle train 1.

The vehicle driver in the passenger compartment of the vehicle has capability to selectively activate the above-described trailer brake-steer feature, such as by toggling a switch on the vehicle dashboard, when the vehicle driver desires to back up the trailer 12 in reverse. Other ways of selectively activating the above-described feature are possible. When activation is selected, a differential in brake pressure is applied on the one side of the wheel ends of the trailer 12 as the trailer 12 is backing up in reverse, as will be described herein.

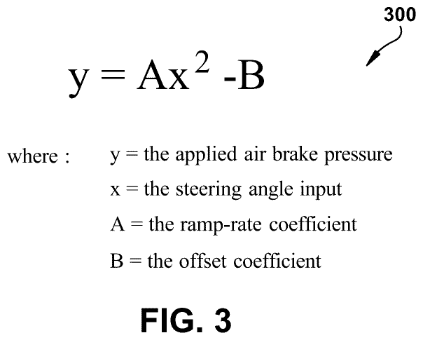

Referring to FIG. 3, an example equation 300 used in the steering control apparatus of FIG. 2 to calculate a differential in brake pressure that is to be applied to the one side of the wheel ends of the trailer 12 as a function of steering angle of the steering-angle positon sensor 120 is illustrated. In equation 300, “y” represents the applied differential in brake pressure, “x” represents the steering angle input on line 122 to the tractor steering controller 110, “A” is a ramp-rate coefficient, and “B” is an offset coefficient.

In equation 300, the steering angle input “x” comprises a squared relationship in which the applied differential in brake pressure “y” on the one side of the wheel ends of the trailer 12 varies as a square of the steering angle input “x”. Also in equation 300, the square of the steering angle input “x” is modified with a combination of the ramp-rate coefficient “A” and the offset coefficient “B” to yield the applied differential in brake pressure “y” on the one side of the wheel ends of the trailer 12. Preferably, the ramp-rate coefficient comprises a value between about 0.01 and about 0.05, and the offset coefficient comprises a value between about −20 and about +20.

Each of the coefficients “A” and “B” is empirically determined to calibrate the coefficient to the particular model/type of trailer. The calibrated coefficients are stored in memory, and reflect a trailer profile that is individually programmed for the particular trailer. The trailer profiles can be made available for selection by either the vehicle driver or fleet management. The ramp-rate coefficient “A” represents the speed (i.e., how fast) at which the air brake pressure “y” is to be applied to the one side of the wheel ends of the trailer 12 in response to a request for a braking application. The offset coefficient “B” represents a preloading function to overcome timing delays due to inertia of components of the vehicle braking system in responding to the request for a braking application.

Since the relationship between “y” and “x” is a non-linear relationship in accordance with the present disclosure, the power to which “x” can be raised may be any power other than a power of one. Accordingly, the steering angle “x” is being raised to a power other than one, and is then modified using the combination of the ramp-rate coefficient “A” and the offset coefficient “B” to yield the applied differential in brake pressure “y” that is to be applied to the one side of the wheel ends of the trailer 12.

It should be apparent that the applied differential in brake pressure on the one side of the wheel ends of the trailer 12 is proportional to a product of the ramp-rate coefficient “A” times the steering angle “x” raised to a power other than one. The offset coefficient “B” is then subtracted from (or alternatively summed with) the quantity of the product of the ramp-rate coefficient “A” times the steering angle “x” raised to a power other than one to yield the applied differential in brake pressure “y”.

It should also be apparent that means is provided for transmitting a signal to apply a differential in brake pressure on one side of opposite wheel ends of the trailer 12 such that relationship between the applied differential in brake pressure on the one side of the wheel ends of the trailer 12 and steering angle of steering wheels of the tractor 2 is other than a linear relationship. The steering angle varies linearly as a function of steering input from a driver when the steering-angle position sensor 120 is operating in a working range (e.g., between −45 degrees and +45 degrees). The applied differential in brake pressure on the one side of the wheel ends of the trailer 12 varies non-linearly as a function of the steering angle in the working range of the steering-angle position sensor 120.

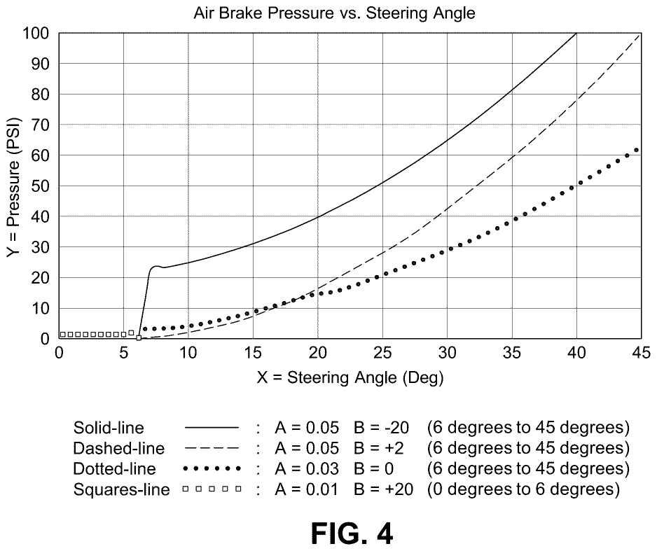

Referring to FIG. 4, a number of graphs is illustrated using various ramp-rate coefficients “A” and offset coefficients “B” in equation 300 of FIG. 3. In particular, each graph line in FIG. 4 shows the non-linear relationship between the steering angle “x” that is being provided on line 122 from the steering-angle position sensor 120 and the air brake pressure “y” that is being applied to the one side of the wheel ends of the trailer 12.

In FIG. 4, solid-line graph shows air brake pressure “y” varying as a function of steering angle “x” using a ramp-rate coefficient “A” of 0.05 and an offset coefficient “B” of −20. Dashed-line graph shows air brake pressure “y” varying as a function of steering angle “x” using a ramp-rate coefficient “A” of 0.05 and an offset coefficient “B” of +2. Dotted-line graph shows air brake pressure “y” varying as a function of steering angle “x” using a ramp-rate coefficient “A” of 0.03 and an offset coefficient “B” of zero. Squares-line graph shows air brake pressure “y” varying as a function of steering angle “x” using a ramp-rate coefficient “A” of 0.01 and an offset coefficient “B” of +20.

The most aggressive braking application shown in FIG. 4 is provided with a high ramp-rate coefficient (e.g., “A”=0.05) and a negative offset coefficient (e.g., “B”=−20), such as shown in the solid-line graph of FIG. 4. The solid-line graph of FIG. 4 has a range between about six degrees and 45 degrees. There is a “dead zone” below of about six degrees of steering angle in which no air pressure braking is applied. The solid-line graph of FIG. 4 is suitable for trailers with drum brakes and high leakage rates, as well as trailers with significant time delay and high load (e.g., a heavily-loaded trailer with old drum brakes, high leakage, and potentially contaminated brake lines).

In contrast, the least aggressive braking application shown in FIG. 4 is provided with a low ramp-rate coefficient (e.g., “A”=0.01) and a positive offset coefficient (e.g., “B”=+20), such as shown in the squares-line graph of FIG. 4. The squares-line graph of FIG. 4 has a range between about zero degrees and six degrees. The squares-line graph of FIG. 4 is suitable for lightly-loaded trailers with air disc brakes, for example. The squares-line graph of FIG. 4 is especially suitable for a lightly-loaded trailer that has booster valves for reducing brake timing. As can be seen in the squares-line graph of FIG. 4, the air brake pressure “y” is responsive to steering angles “x” up to only about six degrees of steering angle. In this narrow range of steering-angle operation for a lightly-loaded trailer, the air brake pressure “y” applied may be enough to lock the air disc brakes under no load.

Each of the dashed-line graph and the dotted-line graph shown in FIG. 4 is provided with coefficients “A” and “B” that are between the higher limits and the lower limits described above for the solid-line graph and the squares-line graph shown in FIG. 4. Each of the dashed-line graph and dotted-line graph of FIG. 4 has a range between about six degrees and 45 degrees. In particular, the dotted-line graph of FIG. 4 is provided with a ramp-rate coefficient of “A” =0.03 and an offset coefficient of “B” =zero, both of which are at the midpoint of their respective high and low limits.

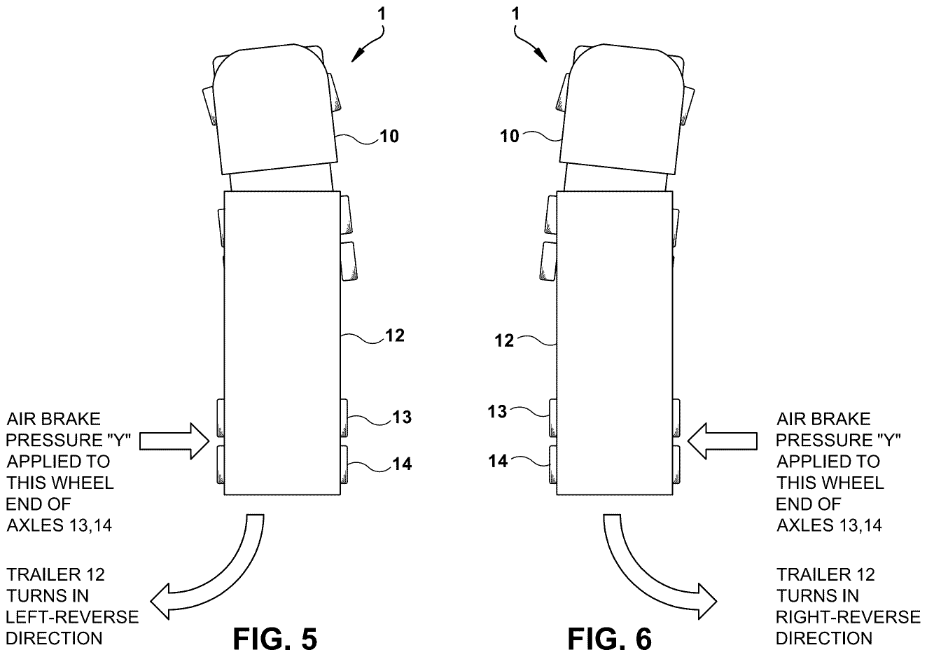

Referring to FIG. 5, the trailer 12 of the vehicle train 1 of FIG. 1 is shown being brake-steered in a left-reverse direction, as viewed looking at FIG. 5. When air brake pressure “y” is applied to the left-wheel end of wheel axles 13, 14, a torque acts on the trailer 12 such that the trailer 12 drags and pivots about the left-wheel end of the trailer 12, resulting in the trailer 12 turning in the left-reverse direction as the trailer 12 continues to back up in the reverse direction. The turning radius of the left-reverse turn of the trailer 12 varies as a function of the amount of air brake pressure “y” applied as calculated using the equation 300 of FIG. 3. The turning radius decreases as the air brake pressure “y” increases, and increases as the air brake pressure “y” decreases. The wheels at the left-wheel end of wheel axles 13, 14 may lock as the trailer 12 backs up in the reverse direction.

Referring to FIG. 6, the trailer 12 of the vehicle train 1 of FIG. 1 is shown being brake-steered in a right-reverse direction, as viewed looking at FIG. 6. When air brake pressure “y” is applied to the right-wheel end of wheel axles 13, 14, a torque acts on the trailer 12 such that the trailer 12 drags and pivots about the right-wheel end of the trailer 12, resulting in the trailer 12 turning in the right-reverse direction as the trailer 12 continues to back up in the reverse direction. The turning radius of the right-reverse turn of the trailer 12 varies as a function of the amount of air brake pressure “y” applied as calculated using the equation 300 of FIG. 3. The turning radius decreases as the air brake pressure “y” increases, and increases as the air brake pressure “y” decreases. The wheels at the right-wheel end of wheel axles 13, 14 may lock as the trailer 12 backs up in the reverse direction.

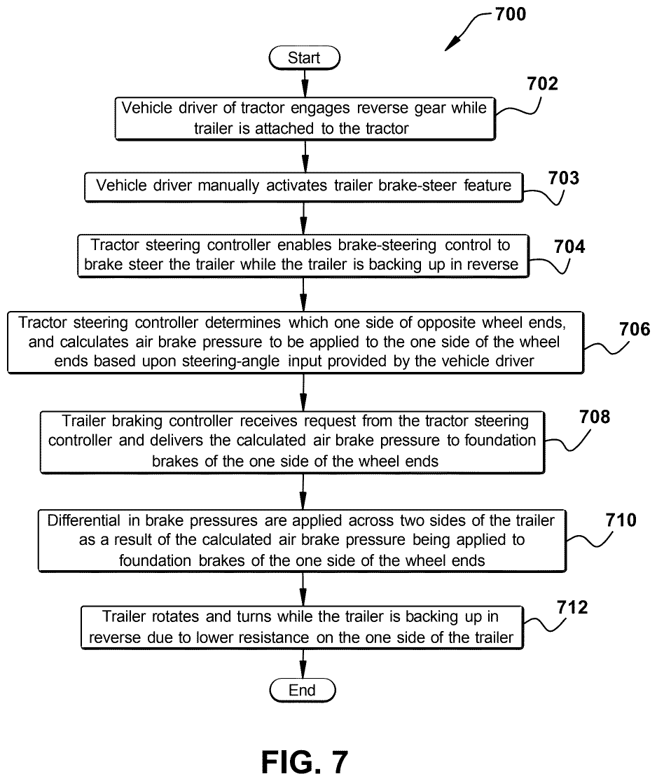

Referring to FIG. 7, a flow diagram 700 depicts a method of operating a steering control apparatus of a vehicle train having a tractor towing a trailer in accordance with an embodiment. In block 702, a vehicle driver of a tractor engages reverse gear while a trailer is attached to the tractor. The vehicle driver also manually activates a trailer brake-steer feature, as shown in block 703. Then in block 704, a tractor steering controller enables brake-steering control to brake steer the trailer while the trailer is backing up in reverse. The process proceeds to block 706.

In block 706, the tractor steering controller determines which one side of opposite wheel ends, and calculates air brake pressure to be applied to the one side of the wheel ends based upon steering-angle input provided by the vehicle driver. The process then proceeds to block 708 in which a trailer braking controller receives request from the tractor steering controller and delivers the calculated air brake pressure to foundation brakes of the one side of the wheel ends.

Then in block 710, differential in brake pressures are applied across two sides of the trailer as a result of the calculated air brake pressure being applied to foundation brakes of the one side of the wheel ends. The trailer rotates and turns while the trailer is backing up in reverse due to lower resistance on the one side of the trailer, as shown in block 712. The process then ends.

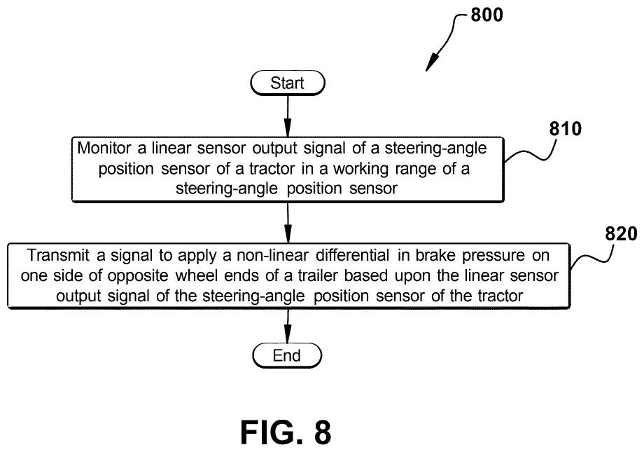

Referring to FIG. 8, a flow diagram 800 depicts a method of operating a steering control apparatus of a vehicle train having a tractor towing a trailer in accordance with another embodiment. In block 810, a linear sensor output signal of a steering-angle position sensor of the tractor in a working range of the steering-angle position sensor is monitored. The process proceeds to block 820 in which a signal is transmitted to apply a non-linear differential in brake pressure on one side of opposite wheel ends of the trailer based upon the linear sensor output signal of the steering-angle position sensor of the tractor. The process then ends.

In some embodiments, the linear sensor output signal of the steering-angle position sensor is raised to a power other than one to yield the non-linear differential in brake pressure to be applied on the one side of the wheel ends of the trailer.

In some embodiments, the linear sensor output signal that has been raised to a power other than one is modified using a combination of a ramp-rate coefficient and an offset coefficient to yield the differential in brake pressure to be applied on the one side of the wheel ends of the trailer.

In some embodiments, the method is performed by a controller having a memory executing one or more programs of instructions which are tangibly embodied in a program storage medium readable by the controller.

A number of advantages result by providing the vehicle train 1 with the above-described steering control apparatus 100. One advantage is that the vehicle driver is provided with brake-steering control of the trailer 12 while the trailer 12 is backing up in reverse. Depending upon the request of the vehicle driver, the tractor steering controller 110 can request a different level of drag on either side of the trailer 12, thereby making backing up of the trailer 12 in reverse more predictable and precise.

Another advantage is that the vehicle driver can selectively activate the above-described backing up process when desired. After activation, deactivation may occur in different ways. As an example, deactivation may occur by shifting the gear of the vehicle to either drive or neutral, for example. Other ways of deactivation are possible.

Still another advantage is that the vehicle driver can back up the tractor 2 in a straight line and need not worry about jackknifing the trailer 12 while backing up in reverse since the tractor steering controller 110 has capability to control the backing up process without having to lock up a wheel.

Program instructions for enabling the tractor steering controller 110 (FIG. 1) to perform operation steps in accordance with corresponding flow diagrams may be embedded in memory internal to the controller. Alternatively, or in addition to, program instructions may be stored in memory external to the controller. As an example, program instructions may be stored in memory internal to a different controller of the vehicle. Program instructions may be stored on any type of program storage media including, but not limited to, external hard drives, flash drives, and compact discs. Program instructions may be reprogrammed depending upon features of the particular controller.

Aspects of disclosed embodiments may be implemented in software, hardware, firmware, or a combination thereof. The various elements of the system, either individually or in combination, may be implemented as a computer program product tangibly embodied in a machine-readable storage device for execution by a processor. Various steps of embodiments may be performed by a computer processor executing a program tangibly embodied on a computer-readable medium to perform functions by operating on input and generating output. The computer-readable medium may be, for example, a memory, a transportable medium such as a compact disk or a flash drive, such that a computer program embodying aspects of the disclosed embodiments can be loaded onto a computer.

Although the above description describes use of only one controller (i.e., the tractor steering controller 110 in the tractor 2), it is conceivable that any vehicle controller and any number of controllers may be used. As an example, another controller of the vehicle, or a dedicated controller, may be used in place of or in addition to the tractor steering controller 110. Moreover, it is conceivable that any type of controller may be used. Suitable controllers for use in vehicles are known and, therefore, have not been described. Accordingly, the program instructions of the present disclosure can be stored on program storage media associated with one or more vehicle controllers.

While the present invention has been illustrated by the description of example processes and system components, and while the various processes and components have been described in detail, applicant does not intend to restrict or in any way limit the scope of the appended claims to such detail. Additional modifications will also readily appear to those skilled in the art. The invention in its broadest aspects is therefore not limited to the specific details, implementations, or illustrative examples shown and described. Accordingly, departures may be made from such details without departing from the spirit or scope of applicant's general inventive concept.

What is claimed is:

1. A steering control apparatus for a vehicle train having a tractor towing a trailer, the steering control apparatus comprising:
a steering-angle position sensor arranged to provide a sensor output signal indicative of steering angle of steering wheels of the tractor; and
a controller arranged to (i) monitor the sensor output signal of the steering-angle position sensor, and (ii) transmit a signal to apply a differential in brake pressure on one side of opposite wheel ends of the trailer, wherein the applied differential in brake pressure on the one side of the wheel ends of the trailer varies as a non-linear function of the sensor output signal indicative of steering angle of steering wheels of the tractor.

2. A steering control apparatus according to claim 1, wherein the sensor output signal indicative of steering angle of steering wheels of the tractor varies linearly as a function of steering input from a driver when the steering-angle position sensor is operating in a target range between about −45 degrees and about +45 degrees as the tractor is engaged in reverse gear and moving the trailer in reverse direction of the vehicle train.

3. A steering control apparatus according to claim 2, wherein the applied differential in brake pressure on the one side of the wheel ends of the trailer varies non-linearly in a brake-pressure range between about zero pounds-per-square-inch (psi) and about 120 psi as a function of the sensor output signal indicative of steering angle of steering wheels of the tractor when the steering-angle position sensor is operating in the target range between about −45 degrees and about 45 degrees.

4. A steering control apparatus according to claim 2, wherein the applied differential in brake pressure on the one side of the wheel ends of the trailer varies as a square of the sensor output signal indicative of steering angle of steering wheels of the tractor.

5. A steering control apparatus according to claim 4, wherein the square of the sensor output signal indicative of steering angle of steering wheels of the tractor is modified with a combination of a ramp-rate coefficient and an offset coefficient to yield the applied differential in brake pressure on the one side of the wheel ends of the trailer.

6. A steering control apparatus according to claim 2, wherein the sensor output signal of the steering-angle position sensor is raised to a power other than one.

7. A steering control apparatus according to claim 6, wherein the sensor output signal that has been raised to a power other than one is modified using a combination of a ramp-rate coefficient and an offset coefficient to yield the applied differential in brake pressure on the one side of the wheel ends of the trailer.

8. A steering control apparatus according to claim 7, wherein (i) the ramp-rate coefficient comprises a value between about 0.01 and about 0.05 and (ii) the offset coefficient comprises a value between about −20 and about +20.

9. A steering control apparatus for a vehicle train having a tractor towing a trailer, the steering control apparatus comprising:
a steering-angle position sensor arranged to provide a sensor output signal indicative of steering angle of steering wheels of the tractor; and
a controller arranged to (i) monitor the sensor output signal of the steering-angle position sensor, and (ii) transmit a signal to apply a differential in brake pressure on one side of opposite wheel ends of the trailer, wherein the applied differential in brake pressure on the one side of the wheel ends of the trailer varies as a function of the sensor output signal of the steering-angle position sensor modified by a ramp-rate coefficient and an offset coefficient.

10. A steering control apparatus according to claim 9, wherein (i) the ramp-rate coefficient comprises a value between about 0.01 and about 0.05 and (ii) the offset coefficient comprises a value between about −20 and about +20.

11. A steering control apparatus according to claim 9, wherein the applied differential in brake pressure on the one side of the wheel ends of the trailer is proportional to a product of the ramp-rate coefficient times the sensor output signal raised to a power other than one.

12. A steering control apparatus according to claim 11, wherein the offset coefficient is subtracted from the quantity of the product of the ramp-rate coefficient times the sensor output signal raised to a power other than one to yield the applied differential in brake pressure on the one side of the wheel ends of the trailer.

13. A steering control apparatus for a vehicle train having a tractor towing a trailer, the steering control apparatus comprising:
a steering-angle position sensor arranged to provide a sensor output signal indicative of steering angle of steering wheels of the tractor; and
means for transmitting a signal to apply a differential in brake pressure on one side of opposite wheel ends of the trailer such that relationship between the applied differential in brake pressure on the one side of the wheel ends of the trailer and the sensor output signal indicative of steering angle of steering wheels of the tractor is other than a proportional linear relationship.

14. A steering control apparatus according to claim 13, wherein the relationship between the applied differential in brake pressure on the one side of the wheel ends of the trailer and the sensor output signal indicative of steering angle of steering wheels of the tractor comprises a squared relationship in which the applied differential in brake pressure on the one side of the wheel ends of the trailer varies as a square of the sensor output signal indicative of steering angle of steering wheels of the tractor.

15. A steering control apparatus according to claim 14, wherein the square of the sensor output signal indicative of steering angle of steering wheels of the tractor is modified with a combination of a ramp-rate coefficient and an offset coefficient to yield the applied differential in brake pressure on the one side of the wheel ends of the trailer.

16. A steering control apparatus according to claim 13, wherein (i) the sensor output signal indicative of steering angle of steering wheels of the tractor varies linearly as a function of steering input from a driver when the steering-angle position sensor is operating in a working range of the steering-angle position sensor, and (ii) the applied differential in brake pressure on the one side of the wheel ends of the trailer varies non-linearly as a function of the sensor output signal in the working range of the steering-angle position sensor.

17. A method of operating a steering control apparatus of a vehicle train having a tractor towing a trailer, the method comprising:
monitoring a linear sensor output signal of a steering-angle position sensor of the tractor in a working range of the steering-angle position sensor; and
transmitting a signal to apply a non-linear differential in brake pressure on one side of opposite wheel ends of the trailer based upon the linear sensor output signal of the steering-angle position sensor of the tractor.

18. A method according to claim 17 further comprising:
raising the linear sensor output signal of the steering-angle position sensor to a power other than one to yield the non-linear differential in brake pressure to be applied on the one side of the wheel ends of the trailer.

19. A method according to claim 18 further comprising:
modifying the linear sensor output signal that has been raised to a power other than one using a combination of a ramp-rate coefficient and an offset coefficient to yield the differential in brake pressure to be applied on the one side of the wheel ends of the trailer.

20. A method according to claim 17, wherein the method is performed by a controller having a memory executing one or more programs of instructions which are tangibly embodied in a program storage medium readable by the controller.
